(19) United States
(12) Patent Application Publication
(10) Pub. No.: US 2026/0351761 A1
(43) Pub. Date: Nov. 5, 2026

(54) Storage Cell Assembly Comprising a Load Distribution Component

(71) Applicant: Bayerische Motoren Werke Aktiengesellschaft, Muenchen (DE)

(72) Inventors: Matthias BRUTSCHER, Muenchen (DE); Attila FARKAS, Muenchen (DE); Andreas KLAFFKI, Unterschleissheim (DE); Philip KOTTER, Muenchen (DE); Sven LAENGLACHER, Muenchen (DE); Philipp PETZ, Muenchen (DE); Patrick SCHMITZ, Muenchen (DE)

(21) Appl. No.: 19/489,662

(22) PCT Filed: Mar. 13, 2025
(86) PCT No.: PCT/DE2025/100261

§ 371 Date: Dec. 3, 2025

(30) Foreign Application Priority Data
Apr. 12, 2024 (DE) 10 2024 110 336.1

(51) Int. Cl. H01M 50/242; B60L 50/64; H01M 50/213; H01M 50/249

(52) U.S. Cl. CPC H01M 50/242; B60L 50/64; H01M 50/213; H01M 50/249; H01M 2220/20

(57) ABSTRACT

A storage cell assembly includes a first housing wall, and at least one storage cell. The at least one storage cell is arranged along a first axis behind the first housing wall. The storage cell has a side wall that extends along the first axis and supports an edge region of a first end face of the storage cell. A load distribution component is arranged between the first housing wall and the first end face of the storage cell. The load distribution component is designed such that, as a result of a force acting along the first axis on the first housing wall in the direction of the storage cell, the edge region of the first end face of the storage cell is subjected to a greater force than a central region of the first end face of the storage cell.

### BACKGROUND AND SUMMARY

The disclosure relates to a storage cell assembly for an electrical energy store.

An at least partially electrically driven vehicle comprises an energy store for storing electrical energy for operating an electric drive motor of the vehicle. The energy store typically comprises a storage cell assembly having a multiplicity of individual storage cells, in particular having a multiplicity of round cells, which is arranged in a housing of the energy store. The energy store can also comprise a cell contacting system designed to electrically conductively interconnect the individual storage cells according to a specific electrical interconnection (e.g. a 3P, 4P or 5P interconnection).

During operation of the vehicle, the individual storage cells of the storage cell assembly may be subject to mechanical loads that can lead to one or more storage cells being damaged.

The present document is concerned with the technical object of providing efficient and reliable protection for the storage cells of a storage cell assembly against mechanical loads.

This and other objects are achieved by each of the embodiments herein. Advantageous embodiments are also described herein. It is pointed out that additional features of a patent claim that is dependent on an independent patent claim without the features of the independent patent claim or only in combination with a subset of the features of the independent patent claim can form a dedicated disclosure that is independent of the combination of all of the features of the independent patent claim and that can be made the subject matter of an independent claim, a divisional application or a subsequent application. This applies in the same way to technical teachings that are described in the description and that can form an disclosure independent of the features of the independent patent claims.

According to one aspect, a storage cell assembly is described. The storage cell assembly can be part of an energy store. E.g. the storage cell assembly can be in the form of a storage module for an energy store. The storage cell assembly may be designed to store electrical energy for operating an electric drive machine of a motor vehicle. The storage cell assembly can have a rated voltage of 100 V or more, in particular 300 V or more.

The storage cell assembly typically comprises a housing that encloses one or more storage cells, in particular a multiplicity of storage cells. The storage cell assembly, in particular the housing of the storage cell assembly, comprises a first housing wall. In addition, the storage cell assembly comprises at least one storage cell that is arranged along a first axis behind the first housing wall and that has a first end face facing the first housing wall. The first axis can correspond to the z axis depicted in this document.

Typically, the storage cell assembly comprises a multiplicity of storage cells (e.g. 10 or more, or 50 or more, or 100 or more storage cells) that are arranged transversely with respect to the first axis next to one another behind the first housing wall.

Each of the individual storage cells can have a (cylindrical) side wall that extends along the first axis. The first end face may be arranged at a first end of the side wall (and can be supported by the side wall). Each of the individual storage cells can have a second end face, each of which is arranged at the (opposite) second end of the side wall of the respective storage cell. Each of the individual storage cells can be in the form of a round cell. Furthermore, each of the individual storage cells can be in circular cylindrical form around the first axis (each with a circular cylindrical side wall).

A storage cell typically has one or more electrically conductive contact points (each of which is also referred to as a terminal) on the first end face. In particular, the first end face of a storage cell can have a first contact point having a first electrical polarity and a second contact point having a second electrical polarity, the second polarity being the opposite of the first polarity. The first polarity can be the positive polarity and the second polarity can be the negative polarity (or precisely the other way round).

The storage cell assembly can comprise an (electrically conductive) cell contacting system designed to electrically conductively interconnect the multiplicity of storage cells. The cell contacting system may be arranged between the first housing wall and the first end faces of the multiplicity of storage cells. The cell contacting system can comprise contact elements, each of which is electrically conductively connected to a contact point of a storage cell. Each of the individual contact elements of the cell contacting system can rest on a contact point of a storage cell (as a result of which a contact element of the cell contacting system is arranged between a contact point of a particular storage cell and the first housing wall).

The aspects described below for a storage cell can be applicable to all individual storage cells of the multiplicity of storage cells of the storage cell assembly in an appropriate manner. In particular, a pressure relief component and/or a load distribution component can be provided for each individual storage cell.

The first end face of a storage cell can have a contact-connection subregion in which at least one contact point for the purpose of electrical contact-connection of the storage cell is arranged. The contact-connection subregion can contain in particular the second contact point of the storage cell.

The first end face of the storage cell may be divided into an (annular) edge region and a central region, the edge region being able to enclose the central region. The edge region of the first end face can rest on the (circular cylindrical) side wall of the storage cell. The edge region can have the shape of a circular ring that encloses the circular central region. The contact-connection subregion may be arranged in the central region, in particular in the center of the central region, of the first end face of the storage cell.

The storage cell assembly can comprise a pressure relief component for a particular storage cell, which pressure relief component is arranged between the first housing wall and the (second) contact point of the storage cell, in particular between the first housing wall and the contact element of the cell contacting system that is arranged on the (second) contact point of the storage cell. The pressure relief component may be designed in such a way that, as a result of a force acting along the first axis (from outside the storage cell assembly) on the first housing wall in the direction of the storage cell, the (second) contact point is subject to a lesser force than the first end face outside the contact-connection subregion.

The first housing wall may be designed in such a way that the force acting on the first housing wall is distributed substantially evenly over a subregion of the first housing wall that corresponds to the first end face of the storage cell. The pressure relief component arranged between the first housing wall and the first end face produces an uneven distribution of force, as a result of which the force acting on the contact-connection subregion of the first end face of the storage cell is smaller than the force acting on the residual subregion of the first end face outside the contact-connection subregion. The force acting on the contact-connection subregion of the first end face of the storage cell is preferably smaller than the force acting on the residual subregion of the first end face by a factor of 2 or more, or 5 or more.

The storage cell assembly typically comprises a multiplicity of accordingly designed pressure relief components for the applicable multiplicity of storage cells.

Therefore, a storage cell assembly is described that comprises one or more pressure relief components, each of which is designed to shield the (second) contact points of one or more storage cells from external forces. This provides a particularly robust and safe storage cell assembly.

The storage cell assembly can comprise a (foamed and/or cured) filling compound between the residual subregion of the first end face outside the contact-connection subregion and the housing wall. The deformation resistance of the pressure relief component along the first axis is preferably lower, in particular lower by a factor of 2 or more, than the deformation resistance of the filling compound along the first axis. This produces an uneven distribution of force on the first end face of a storage cell in a particularly reliable manner.

The term “deformation resistance” used in this document should preferably be understood to mean a mechanical resistance to, in particular, but not exclusively, compressible deformations. A deformation resistance can be represented purely elastically (for example the modulus of elasticity), elastoplastically (for example the modulus of elasticity in combination with a modulus of plasticity or with a solidification law, etc.) or completely non-linearly (for example hyperelastically). The deformation resistance can therefore include a modulus of elasticity, in particular can be a modulus of elasticity.

The deformation resistance can be defined in such a way that the force (per unit area) that needs to be applied to produce a specific deformation, in particular strain, increases as the deformation resistance increases. The deformation resistance can depend on a ratio of resultant stress to resultant strain or compression.

A first component can have a first deformation resistance, and a second component can have a second deformation resistance, the second deformation resistance being greater than the first deformation resistance. If the same force (per unit area), in particular the same stress, is produced for both components, this can lead to the first component (due to the lower deformation resistance) being deformed (in particular strained or compressed) to a greater extent than the second component. On the other hand, if both components are deformed (in particular strained or compressed) in the same way, this can lead to the first component (due to the lower deformation resistance) having lower stress than the second component.

The pressure relief component can comprise a foam cushion (comprising an elastic foam) arranged between the (second) contact point of a storage cell and the first housing wall. Alternatively or additionally, the pressure relief component can comprise an air-filled space, in particular an air-filled well, the space, in particular the well, being arranged between the (second) contact point and the first housing wall. This provides a pressure relief component in a particularly efficient and reliable manner.

The second contact point of a storage cell can protrude along the first axis from the first end face in the direction of the first housing wall, in particular by 10% or more of the overall distance between the first end face and the first housing wall. On the other hand, the first contact point may be arranged (completely) within the first end face of the storage cell. The pressure relief component may be arranged in spatially confined fashion between the second contact point and the first housing wall and not between the first contact point and the first housing wall. This produces particularly reliable protection for the protruding second contact point.

The pressure relief component can extend transversely with respect to the first axis via the entire contact-connection subregion of the first end face of a storage cell. The contact-connection subregion can contain not only the (second) contact point but also an electrical fuse and/or a sensor, in particular a voltage sensor. These one or more additional components are therefore likewise protected by the pressure relief component, and so the reliability and safety of the storage cell assembly are increased further.

As already described, a storage cell typically has a (cylindrical) side wall that extends along the first axis and that supports the first end face of the storage cell in the (annular) edge region of the first end face. The storage cell assembly can comprise a load distribution component arranged between the first housing wall and the first end face of the storage cell. The load distribution component may be designed in such a way that, as a result of the force acting along the first axis on the first housing wall, the edge region of the first end face of the storage cell is subject to a greater force (in particular a force greater by a factor of 2 or more) than the first end face in the central region outside the edge region.

The storage cell assembly can comprise a multiplicity of accordingly designed load distribution components for the applicable multiplicity of storage cells.

The provision of load distribution components for the individual storage cells of the storage cell assembly increases the robustness and safety of the storage cell assembly further.

The load distribution component for a storage cell can have a greater deformation resistance, in particular a deformation resistance greater by a factor of 5 or more, along the first axis than the pressure relief component. Alternatively or additionally, the load distribution component can be made of a non-elastic material and the pressure relief component can be made of an elastic material. This provides a particularly robust and safe storage cell assembly.

The load distribution component for a storage cell can have a base that extends transversely with respect to the first axis along the first housing wall. Furthermore, the load distribution component can have an edge that extends along the first axis away from the base in the direction of the first end face of the storage cell, and that is supported in locally confined fashion on the edge region of the first end face and not on the central region outside the edge region. The load distribution component can therefore be in cup-shaped form. A load distribution component designed in such a way directs the forces acting on the first housing wall away from the relatively sensitive central region of the first end face of a storage cell in a particularly reliable manner.

The pressure relief component for a storage cell may be arranged in the central region of the first end face between the contact point of the storage cell and the base of the load distribution component. Alternatively or additionally, the base may be curved in the direction of the (second) contact point of the storage cell in the central region of the first end face, as a result of which the base forms a well that is open in the direction of the first housing wall on the central region of the first end face. The base may touch the (second) contact point of the storage cell (or the contact element of the cell contacting system that is arranged on the second contact point). The pressure relief component can be formed by the well, in particular by an air inclusion inside the well. This provides pressure relief components in a particularly efficient manner.

The multiplicity of pressure relief components for the applicable multiplicity of storage cells of the storage cell assembly can be part of an integral subassembly. The multiplicity of load distribution components is preferably likewise part of the integral subassembly. The subassembly may have been added to the first housing wall or to the first end faces of the multiplicity of storage cells during manufacture of the storage cell assembly. The provision of an integral subassembly produces particularly efficient protection for the individual storage cells against the action of force.

The subassembly may be designed in such a way that the multiplicity of load distribution components form a supporting structure. The multiplicity of pressure relief components may be mounted, in particular adhesively foamed, on the supporting structure. This provides the pressure relief components in a particularly efficient manner.

According to another aspect, another storage cell assembly comprising one or more, in particular comprising a multiplicity of, storage cells is described. It should be noted that the features described with regard to a storage cell assembly in this document can also be applied, individually or in combination, to this storage cell assembly. In particular, the features described above can also be applied, individually or in combination, to this storage cell assembly.

As already described, the storage cell assembly comprises a first housing wall, and at least one storage cell that is arranged along the first axis (i.e. along the z axis) behind the first housing wall. The storage cell can have a side wall that extends along the first axis and supports the (annular) edge region of the first end face of the storage cell, which first end face faces the first housing wall.

In addition, the storage cell assembly can comprise a load distribution component that is arranged between the first housing wall and the first end face of the storage cell, and that is designed in such a way that, as a result of a force acting along the first axis (from outside the storage cell assembly) on the first housing wall in the direction of the storage cell, the edge region of the first end face of the storage cell is subject to a greater force (in particular a force greater by a factor of 2 or more) than the central region of the first end face of the storage cell, which central region is arranged outside the edge region. The load distribution components can be made of a non-elastically-deformable material.

As already described, the storage cell assembly typically comprises a multiplicity of storage cells that are arranged transversely with respect to the first axis next to one another behind the first housing wall. Furthermore, the storage cell assembly can comprise a multiplicity of load distribution components for the applicable multiplicity of storage cells.

Therefore, a storage cell assembly is described that comprises one or more load distribution components, each of which is designed to shield the central region of the first end faces of one or more storage cells from external forces. This provides a particularly robust and safe storage cell assembly.

As already described, the load distribution component for a storage cell can have a base that extends transversely with respect to the first axis along the first housing wall. In addition, the load distribution component can have an edge that extends along the first axis away from the base in the direction of the first end face of the storage cell, and that is supported in locally confined fashion on the edge region of the first end face and not on the central region of the end face. This directs the forces past the central region to the edge region of the first end face of the storage cell in a particularly reliable manner.

The cavity between the central region of the first end face of a storage cell and the base of the load distribution component can have a (foamed and/or cured) filling material. In particular, the cavity may be filled with a filling material. The edge of the load distribution component can have a deformation resistance along the first axis that is greater, in particular greater by a factor of 2 or more, than the deformation resistance of the filling material along the first axis. This directs the forces past the central region to the edge region of the first end face of the storage cell in a particularly reliable manner.

The base of the load distribution component can comprise multiple support elements, each of which extends from the base in the direction of the first housing wall, and each of which touches the first housing wall. This produces a particularly reliable transfer of force from the first housing wall to the load distribution component in order to protect the central region of the first end face against the action of forces.

As already described, the base may be curved in the direction of the first end face, in particular in the direction of the (second) contact point on the first end face, in the central region of the first end face of a storage cell, as a result of which the base forms a well that is open in the direction of the first housing wall on the central region of the first end face. The base may touch the central region, in particular the (second) contact point, (or the contact element of the cell contacting system that is arranged in this region). This produces particularly reliable protection for the central region of the first end face, in particular the (second) contact point, of a storage cell.

As already described, the storage cell assembly can have (for each of the individual storage cells) a pressure relief component that is arranged between the first housing wall and the (second) contact point of a storage cell, and that is designed in such a way that, as a result of the force acting along the first axis on the first housing wall, the contact point is subject to a lesser force than the central region of the first end face outside the contact-connection subregion. This produces particularly reliable protection for a storage cell.

The multiplicity of load distribution components for the applicable multiplicity of storage cells of the storage cell assembly are preferably part of an integral subassembly. This produces particularly efficient protection for the storage cells of the storage cell assembly.

According to another aspect, an energy store for storing electrical energy is described. The energy store comprises one or more of the storage cell assemblies described in this document.

According to another aspect, a (road) motor vehicle (in particular an automobile or a truck or a bus or a motorcycle) is described that comprises the energy store described in this document.

It should be borne in mind that the methods, apparatuses and systems described in this document can be used either on their own or in combination with other methods, apparatuses and systems described in this document. In addition, any aspects of the methods, apparatuses and systems described in this document can be combined with one another in a wide variety of ways. In particular, the features of the claims can be combined with one another in a wide variety of ways. Furthermore, features shown between parentheses should be understood to be optional features.

The disclosure is described in more detail below on the basis of exemplary embodiments, where:

### BRIEF DESCRIPTION OF THE DRAWINGS

FIG. 1 is an illustrative vehicle having an energy store for storing electrical energy;

FIG. 2a is an illustrative round cell;

FIG. 2b is an illustrative electrical energy store having multiple storage cells;

FIG. 2c is an illustrative contacting system for an energy store for providing a 4P interconnection;

FIG. 2d is an illustrative contacting system for a 4P interconnection;

FIG. 3 is an illustrative storage cell assembly having a pressure relief component;

FIG. 4 is an illustrative storage cell assembly having a load distribution component; and

FIGS. 5a and 5b each show an illustrative storage cell assembly having one pressure relief component and one load distribution component (per storage cell).

### DETAILED DESCRIPTION OF EMBODIMENTS

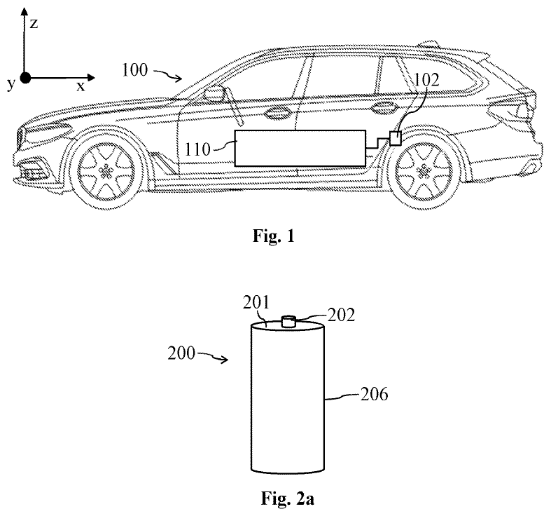

As described at the outset, the present document is thus concerned with protecting the individual storage cells of an electrical energy store against the action of forces and associated damage in an efficient and reliable manner. In this regard, FIG. 1 shows an illustrative vehicle 100 having an electrical energy store 110 for storing electrical energy and an electric drive motor 102 that is operated with electrical energy from the energy store 110.

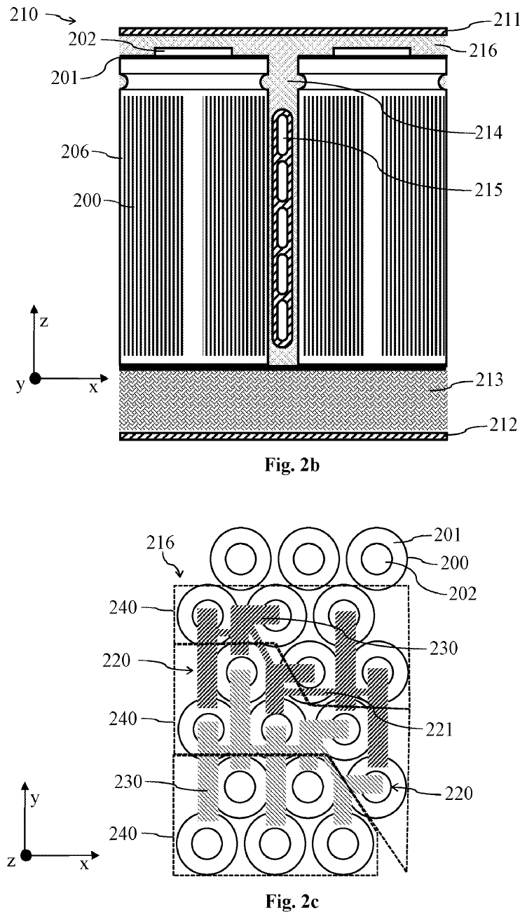

The energy store 110 comprises a multiplicity of storage cells, in particular round cells. FIG. 2a shows an illustrative storage cell 200, in particular a round cell, for an electrical energy store 110. The storage cell 200 has a circular cylindrical shape. An end face of the storage cell 200 has a positive contact point 201 and a negative contact point 202 arranged on it for electrically connecting the storage cell 200. The positive contact point 201 can be formed by the end face of the cylindrical storage cell 200. The end face of the storage cell 200 may be arranged on the end face of a (circular cylindrical) housing side wall 206 of the storage cell 200. The negative contact point 202 can be formed by a bolt that juts out from the end face of the storage cell 200. In another example, the polarity of the contact points 201. 202 may be precisely the other way round.

FIG. 2b shows an illustrative storage cell assembly 210 (e.g. as part of an electrical energy store 110) that comprises a multiplicity of storage cells 200 arranged side by side (i.e. lateral surface by lateral surface) next to one another, in particular in such a way that the contact points 201, 202 of the individual storage cells 200 are arranged on a consistent side (in FIG. 2b, on the top). The storage cell assembly 210 can comprise e.g. 100 or more storage cells 200, or 1000 or more storage cells 200.

The individual storage cells 200 may be electrically conductively connected to one another by means of a cell contacting system 216. The cell contacting system 216 can comprise e.g. a frame having connecting lines or having connecting webs for making electrical contact with the contact points 201, 202 of the individual storage cells 200. The cell contacting system 216 may be arranged on the (contact) side of the storage cells 200 on which the contact points 201, 202 of the storage cells 200 are also arranged. A (second) housing wall 212 of the housing of the storage cell assembly 210 may be arranged on the opposite side of the storage cells 200. The opposite (second) housing wall 212 may be e.g. in the form of a cooling plate for cooling the individual storage cells 200. Underfloor protection 213 may be arranged between the (second) housing wall 212 and the (bottom) end face of the individual storage cells 200.

The storage cell assembly 210 can also comprise a (first) housing wall 211 that covers the cell contacting system 216 (and that is arranged on the opposite side of the storage cell assembly 210 to the second housing wall 212). If necessary, cooling channels 215 can run between the individual storage cells 200 in order to cool the individual storage cells 200. The cavities between the individual components of the storage cell assembly 210 may be filled with a filling compound 214.

As shown in FIG. 2b, the (circular cylindrical) storage cells 200 may be arranged in such a way that the lateral surfaces (i.e. the side walls 206) of directly adjacent storage cells 200 touch. The storage cells 200 may be in a honeycombed arrangement next to one another, in particular in such a way that a subgroup of three particular storage cells 200 encloses a cavity, and/or in such a way that six particular storage cells 200 enclose precisely one other storage cell 200. The (circular cylindrical) storage cells 200 can thus be arranged in a particularly dense manner. In particular, the circular cylindrical storage cells 200 may be arranged with the highest possible packing density in the arrangement.

As shown by way of illustration in FIG. 2c, the storage cells 200 can be interconnected in a specific electrical arrangement by the cell contacting system 216. The storage cell assembly 210 can comprise e.g. Z storage cells 200 divided into subgroups of M storage cells 200 each. The M storage cells 200 of a subgroup can be arranged in electrical parallel with one another by a (sub-)contacting system 220 of the cell contacting system 216. The storage cell assembly 210 then has a so-called MP (e.g. 3P for M=3, 4P for M=4 or 5P for M=5) arrangement.

FIG. 2c shows an illustrative detail from a cell contacting system 216, the detail showing two (sub-)contacting systems 220, each of which is designed to interconnect a subgroup 240 of M=5 storage cells 200 in parallel. The individual contacting systems 220 are also configured to interconnect two different subgroups 240 in series.

A (sub-)contacting system 220 comprises M connecting webs 230, each of which is designed to electrically conductively connect (in pairs) the first contact point 201 of a storage cell 200 from a first subgroup 240 to the second contact point 202 of a storage cell 200 from a second subgroup 240 (as a result of which the first and second subgroups 240 are interconnected in series). Furthermore, a (sub-)contacting system 220 may comprise (M-1) connecting webs 221, each of which is designed to interconnect two storage cells 200 from the same subgroup 240 in parallel.

FIG. 2d shows an illustrative (sub-)contacting system 220 for an MP arrangement, where M=4. The (sub-)contacting system 220 is produced (in particular punched) from a metal sheet. The connecting webs 230 for connecting up two storage cells 200 from different subgroups 240 in series have a first contact region (or a first contact element) 231 (for connection to the first contact point 201 of one storage cell 200) at a first end and a second contact region (or a second contact element) 232 (for connection to the second contact point 202 of the other storage cell 200) at the opposite end.

During operation of the storage cell assembly 210, mechanical effects can occur on the (first) housing wall 211 of the storage cell assembly 210. These can be transferred via the (cured) filling compound 214 to one or more storage cells 200, in particular to the first end faces facing the first housing wall 211 and/or to the contact points 201, 202, facing the first housing wall 211, of one or more storage cells 200, which can lead to the one or more storage cells 200 being damaged. This document describes measures that reliably prevent damage to a storage cell 200 owing to mechanical loads acting on the first housing wall 211 of the storage cell assembly 210.

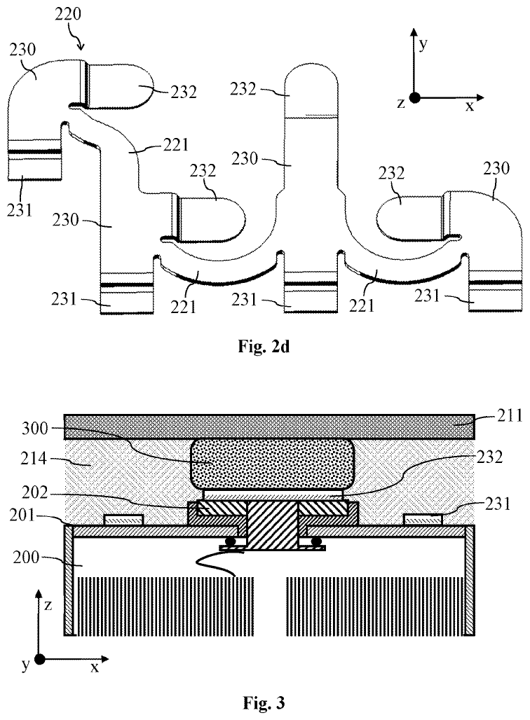

The storage cell assembly 210 shown in FIG. 3 comprises, between the first housing wall 211 and the second contact point 202 of a storage cell 200, a pressure relief component 300 that is designed to shield the second contact point 202 of the storage cell 200 from at least part of a force acting along the z axis on the first housing wall 211. For this purpose, the pressure relief component 300 can have a (significantly) lower deformation resistance than the material arranged in the direct surroundings of the pressure relief component 300 (typically corresponding to the cured filling compound 214). This can cause a force acting on the first housing wall 211 substantially not to be transferred to the second contact point 202 of the storage cell 200, and therefore also not to be able to lead to the storage cell 200 being damaged in the region of the second contact point 202.

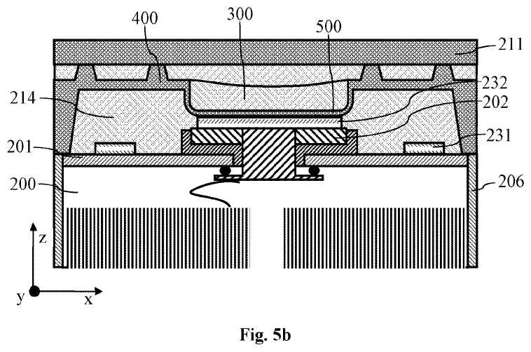

The pressure relief component 300 can be e.g. in the form of a cushion arranged between the first housing wall 211 and the second contact point 202 of the storage cell 200. The cushion can comprise an elastic material, e.g. a foam. Alternatively, the cushion can be in the form of an air cushion filled with air, as shown by way of illustration in FIG. 5b.

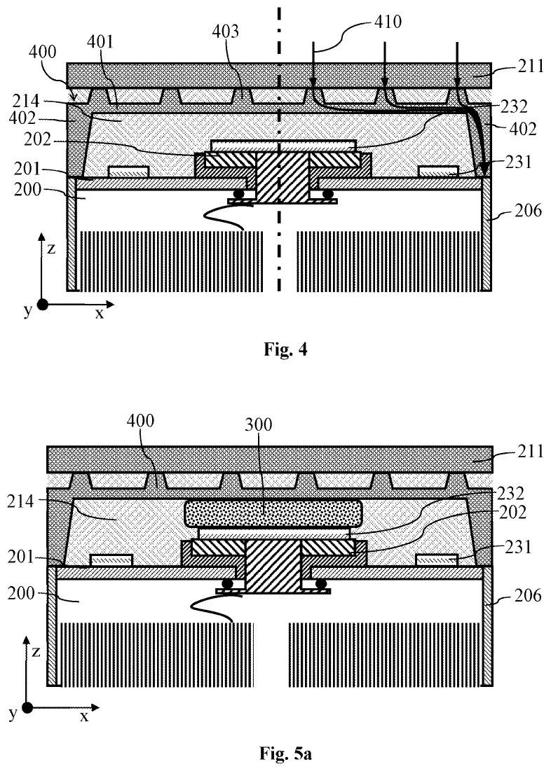

FIG. 4 shows an illustrative storage cell assembly 210 comprising a load distribution component 400 that is designed to direct a force 410 acting on the first housing wall 211 (along the z axis) to the side wall 206 of a storage cell 200. The load distribution component 400 can be in the form of an inverted cup that comprises one or more edges 402 resting on the side wall 206 of the storage cell 200. Furthermore, the cup has a base 401, at least regions of which bear (e.g. via one or more support elements 403) against the first housing wall 211. The force 410 acting on the housing wall 211 is transferred to the base 401 of the cup-shaped load distribution component 400 and is transferred onward from the base 401 to the one or more edges 402 of the cup-shaped load distribution component 400. The one or more edges 402 of the cup-shaped load distribution component 400 are used to transfer the force 410 to the side wall 206 of the storage cell 200. This reliably protects the first end face and/or the contact points 201, 202 of the storage cell 200 against an action of force.

A pressure relief component 300 and a load distribution component 400 can advantageously be used to protect each of the individual storage cells 200, as shown by way of illustration in FIGS. 5a and 5b. This protects the individual storage cells 200 against mechanical loads in a particularly reliable manner.

The storage cell assembly 210 typically comprises a multiplicity of storage cells 200 (e.g. in a honeycombed arrangement). The storage cell assembly 210 can comprise a multiplicity of pressure relief components 300 and/or a multiplicity of load distribution components 400 for the applicable multiplicity of storage cells 200 in order to protect the individual storage cells 200. The multiplicity of pressure relief components 300 and/or the multiplicity of load distribution components 400 can be in the form of an integral subassembly that can be arranged between the first end faces of the multiplicity of storage cells 200 and the first housing wall 211 during production of the storage cell assembly 210. This produces particularly efficient protection against mechanical effects.

During production, the load distribution components 400 can initially be arranged on the end faces of the storage cells 200. Subsequently, the first housing wall 211 of the storage cell assembly 200 can be arranged on the load distribution components 400. Next. filling compound 214 can be introduced into the storage cell assembly 210 in order to fill the cavities between the individual components of the storage cell assembly 210.

The base 401 of the individual load distribution components 400 may be offset in the direction of the individual second contact points 202 of the individual storage cells 200 in the region of the second contact points 202 so that the base 401 of the individual load distribution components 400 touches the second contact points 202 of the individual storage cells 200 (or the contact elements 232 of the cell contacting system 216 that are arranged thereon). The base 401 of a load distribution component 400 can therefore have an elevation in the direction of the second contact point 202 of the applicable storage cell 200 in the region of the second contact point 202. Consequently, a well 500 is formed on the reverse of the base 401 facing away from the second contact point 202, which well is arranged between the second contact point 202 and the first housing wall 211 of the storage cell assembly 200.

The filling compound 214 can be introduced into the storage cell assembly 200 in such a way that the filling compound 214 substantially does not reach the well 500, with the result that the well 500 is filled with air after the filling compound 214 has been introduced and cured. This provides a pressure relief component 300 between the second contact point 202 of a storage cell 200 and the first housing wall 211 in a particularly efficient manner.

As already described, recurring burdens as a result of shock-and vibration-like loads can lead from endurance strength to metallurgical fatigue in the cell housing of the individual storage cells 200 and/or to damage to the cell density beneath the second contact point 202 (or terminal). This can lead e.g. to the storage cell 200 drying out, resulting in the storage cell 200 losing its functionality.

Filling a storage cell assembly 210 with a foaming filling compound 214 that is subsequently cured is a process step that can be monitored only relatively poorly. E.g. different-sized air bubbles can be formed. Consequently, the situation regarding the transfer of mechanical forces 410 from the housing wall 211 of the storage cell assembly 210 to the individual storage cells 200 may be undefined. The measures described in this document produce a defined transfer of mechanical forces 410 from the housing wall 211 of the storage cell assembly 210 to the individual storage cells 200.

It is possible in particular to produce a defined interruption or at least reduction of the mechanical application of load in the vertical pressure direction (i.e. along the z axis) on the cell terminal 202 of a storage cell 200 and/or on the storage cell 200. This can be produced by way of a recess and/or by way of an air inclusion and/or by way of a compressible component (generally by way of a pressure relief component 300) between the housing wall 211 of the storage cell assembly 200 and the cell connector 232 or the cell terminal 202 of the storage cell 200.

The pressure relief component 300 can be introduced into the storage cell assembly 210 by way of a pick-and-place method. This can involve the pressure relief component 300 being placed on the first housing wall 211 or on the contact point 202 (i.e. on the terminal) of a storage cell 200.

The pressure relief component 300 can, if necessary, be foamed onto an additional subassembly, the subassembly possibly having the function of the load distribution component 400 described in this document. This can involve e.g. using a vacuum expansion method. Alternatively or additionally, the pressure relief component 300 can be adhesively foamed onto the subassembly in a process step using a tool. In this case, it can be advantageous for the individual foam pads (i.e. the individual pressure relief components 300) to be connected to one another using webs and/or channels.

As described in connection with FIG. 5b, each of the individual pressure relief components 300 can be in the form of a diving bell (i.e. well 500) to produce an air inclusion. The individual wells 500 can be placed e.g. upside down on a substrate when the filling compound 214 is introduced into the storage cell assembly 210. This reliably prevents filling compound 214 from getting into the wells 500.

The pressure relief components 300 can extend beyond the contact point 202 of a storage cell 200 to one or more adjacent components (e.g. to a fuse and/or to a sensor of the respective storage cell 200). This increases the protective action of the pressure relief component 300 further.

The material of the pressure relief component 300 and/or of the filling compound 214 can be chosen in such a way that degassing takes place that produces a type of aggregation or corona of relatively large pores in the foam in the direct surroundings around the pad (i.e. around the pressure relief component 300) and therefore improves the action of the foam pad (i.e. the pressure relief component 300) further.

Alternatively or additionally, the application of mechanical load to the cell terminal 201, 202 of a storage cell 200 in the vertical pressure direction (i.e. along the z axis) can be monitored and/or reduced by way of a sideward load-transferring and supporting component (i.e. by way of a load distribution component) 400 between the first housing wall 211 and the top of a storage cell 200. It is possible to specifically set up a load path that brings about an application of load preferably into the mechanically load-bearing edge region 206 of the cell top. This load path can either be supported directly on the cell shoulder (i.e. on the edge region of the storage cell 200) or it is possible for one or more other components (e.g. the cell contacting system 216) to be incorporated into the load path, the one or more other components preferably being pressure insensitive.

The present disclosure is not limited to the exemplary embodiments shown. In particular, it should be bome in mind that the description and the figures are intended to illustrate the principle of the proposed methods, apparatuses and systems only by way of illustration.

1.-10. (canceled)

11. A storage cell assembly comprising:
a first housing wall;
at least one storage cell that is arranged along a first axis behind the first housing wall, the storage cell having a side wall that extends along the first axis and supports an edge region of a first end face of the storage cell, which first end face faces the first housing wall; and
a load distribution component that is arranged between the first housing wall and the first end face of the storage cell, and that is designed such that, as a result of a force acting along the first axis on the first housing wall in the direction of the storage cell, the edge region of the first end face of the storage cell is subjected to a greater force than a central region of the first end face of the storage cell, which central region is arranged outside the edge region.

12. The storage cell assembly according to claim 11, wherein
the load distribution component has a base that extends transversely with respect to the first axis along the first housing wall; and
the load distribution component has an edge that extends along the first axis away from the base in the direction of the first end face of the storage cell, and that is supported in locally confined fashion on the edge region of the first end face and not on the central region of the end face.

13. The storage cell assembly according to claim 11, wherein
a cavity between the central region of the first end face of the storage cell and the base of the load distribution component comprises a filling material, in particular is filled with a filling material; and
the edge of the load distribution component has a deformation resistance along the first axis that is greater, in particular greater by a factor of 2 or more, than a deformation resistance of the filling material along the first axis.

14. The storage cell assembly according to claim 11, wherein the base of the load distribution component comprises multiple support elements that extend from the base in the direction of the first housing wall, each of which touches the first housing wall.

15. The storage cell assembly according to claim 11, wherein the base is curved in the direction of the first end face, in particular toward a contact point on the first end face, in the central region of the first end face of the storage cell, such that the base forms a well that is open in the direction of the first housing wall on the central region of the first end face.

16. The storage cell assembly according to claim 11, wherein
the storage cell assembly has at least one contact point in a contact-connection subregion of the central region of the first end face for electrical contact-connection of the storage cell; and
the storage cell assembly comprises a pressure relief component arranged between the first housing wall and the contact point of the storage cell and designed such that, as a result of the force acting along the first axis on the first housing wall, the contact point is subjected to a lesser force than the central region of the first end face outside the contact-connection subregion.

17. The storage cell assembly according to claim 11, wherein the load distribution component is made of a non-elastically-deformable material.

18. The storage cell assembly according to claim 11, wherein
the storage cell assembly comprises a multiplicity of storage cells that are arranged transversely with respect to the first axis next to one another behind the first housing wall; and
the storage cell assembly comprises a multiplicity of load distribution components for the multiplicity of storage cells.

19. The storage cell assembly according to claim 11, wherein the multiplicity of load distribution components is part of an integral subassembly that has been added to the first housing wall or to the first end faces of the multiplicity of storage cells during manufacture of the storage cell assembly.

20. The storage cell assembly according to claim 11, wherein
the storage cell assembly comprises a cell contacting system designed to electrically interconnect the multiplicity of storage cells; and
the cell contacting system is arranged between the first housing wall and the first end faces of the multiplicity of storage cells.
